(19) United States
(12) Patent Application Publication
(10) Pub. No.: US 2011/0175567 A1
(43) Pub. Date: Jul. 21, 2011

(54) Power mouse pad

(76) Inventor: Chira Kidakarn, Lawndale, CA (US)

(21) Appl. No.: 12/930,503

(22) Filed: Jan. 7, 2011

Related U.S. Application Data
(60) Provisional application No. 61/335,533, filed on Jan. 7, 2010.

(51) Int. Cl. H02J 7/00

(52) U.S. Cl. 320/108; 320/107

(57) ABSTRACT

A power mouse pad for a computer includes a rechargeable mouse, a mouse pad having a working surface facilitating the rechargeable mouse to work thereon, a charging element including a first charging unit provided at the mouse pad and a second charging unit provided at the rechargeable mouse to electrically charge the rechargeable mouse when said first charging unit connects with the second charging unit; and a connector provided at the mouse pad for electrically and communicatively connecting with the computer to draw electrical power from the computer in order to charge the rechargeable mouse.

### CROSS REFERENCE OF RELATED APPLICATION

This is a non-provisional application of a provisional application having an application No. 61/335,533 and a filing date Jan. 7, 2010.

### BACKGROUND OF THE PRESENT INVENTION

1. Field of Invention

The present invention relates to a mouse pad and mouse, and more particularly to a mouse pad which is able to charge the battery of the mouse.

2. Description of Related Arts

Personal computer (PC) and laptop computer are widely used in every field of modern life. As the development of the computer related technology, the accessories of computer is also well developed which largely empower the utility of the computer. These accessories include input devices such as keyboard and mouse, external storage such as flash drive and external hard drive, output devices such as speakers 70, and other electronic devices such as printer, cell phone, camera, etc.

All these accessories bring a lot of convenience to the computer users, but also bring a problem. Too many external accessories need to communicate with the computer which makes the connection very complex and confusing. The computer producer has to provide more ports for different standards of connection which increases the costs. The user also has to carry many accessories with his laptop. This is not convenient.

One approach partially solves the problem which is using wireless connection. For example, more and more laptops are using cordless mice. The cordless mouse communicates with the computer through wireless technology which breaks the limitation of a cord. Now another problem comes. These wireless devices have to carry power supply which is battery by themselves. So replacing or recharging of battery gives some extra effort for the user to take care. Therefore, it is necessary to necessary to organize and simplify the connection, and provide convenient power for those cordless devices. Because mouse and mouse pad are the devices that every computer needs, they are employed in the present invention for solving the problems mentioned above.

### SUMMARY OF THE PRESENT INVENTION

Almost every computer has a mouse, and a mouse pad is also necessary to assist the performance of the mouse. They are the devices a user muse carry with his/her laptop, and are always connected with his/her PC. Therefore in the present invention, the mouse pad is utilized to organize the external connection of the computer, and to charge the cordless mouse.

The main object of the present invention is to provide a power mouse pad which provides power to the cordless mouse.

Another object of the present invention is to provide a power mouse pad which charges the mouse without wire.

Another object of the present invention is to provide a power mouse pad which charges the mouse with wire.

Another object of the present invention is to provide a power mouse pad which is easy to align the mouse for charging.

Another object of the present invention is to provide a power mouse pad which is able to indicate the status of charging.

Another object of the present invention is to provide a power mouse pad which organizes the connection of the accessory of the computer.

Another object of the present invention is to provide a power mouse pad which provides ports for external devices to connect with the computer.

Another object of the present invention is to provide a power mouse pad which simplifies the external connection of the computer.

Another object of the present invention is to provide a power mouse pad which carries personal information of the user to configure the computer connected with the mouse pad as the user's preference.

Another object of the present invention is to provide a power mouse pad which reduces the items the user needs to carry with.

In order to accomplish the above objects, the present invention provides a power mouse pad for a computer, comprising:

a mouse communicatively connected with the computer wirelessly which comprises a rechargeable battery;

a working surface facilitating the mouse to work;

a charging element arranged inside the mouse pad to charge the rechargeable battery of the mouse; and

a connector electrically and communicatively connected with the computer.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of the mouse pad of the present invention.

FIG. 2 is a top view of the mouse pad of the present invention.

### DETAILED DESCRIPTION OF THE PREFERRED EMBODIMENT

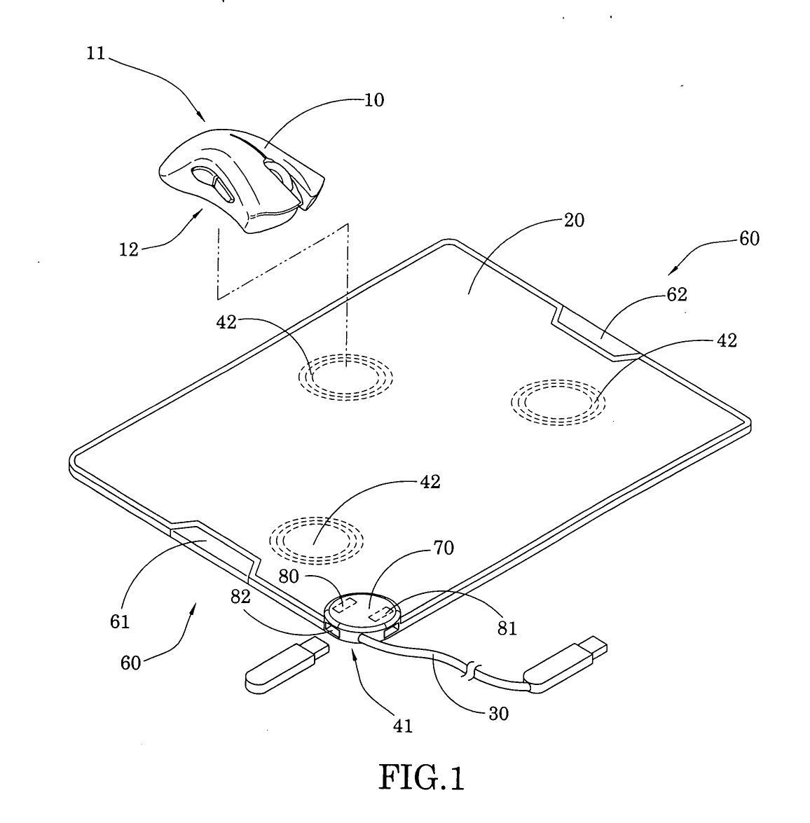

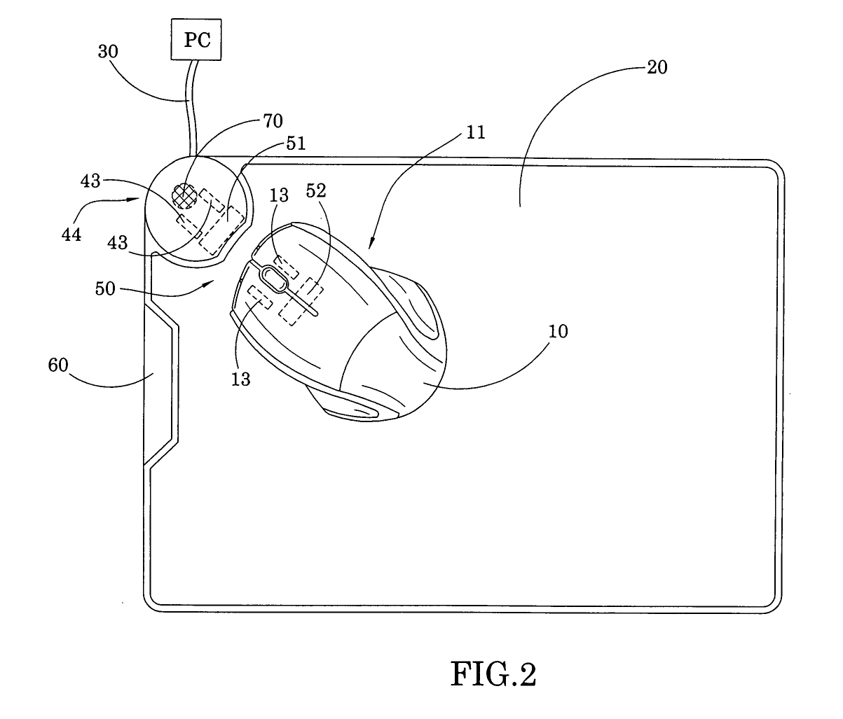

Referring to the FIGS. 1 and 2 of the drawings, in a preferred embodiment, the mouse pad of the present invention comprises a mouse 10 and a working surface 20. The mouse 10 is communicatively connected with a computer wirelessly. The computer includes desktop, laptop, and other electronic devices with processor. When the mouse 10 is sliding on the working surface 20, the mouse 10 senses the relative movement upon the mouse pad and generate signals. The mouse 10 then transfers the signals to the computer as input to control the computer. The communication between the mouse 10 and the computer is using current technology such as electoral-magnetic waves which is known by person skilled in the art. The mouse 10 further comprises a rechargeable battery 11 providing power for the performance of the mouse 10 which is rechargeable.

The mouse pad further comprises a connector 30 electrically connected with the computer, and a charging element 40 integrated within the mouse pad to charge the rechargeable battery 11 of the mouse 10. The connector 30 connects the mouse pad and the computer electrically and communicatively. In a preferred embodiment, the connector 30 is a USB connector 30. In this manner the computer is able to provide power to the mouse pad, and communicate with the mouse pad with data. The charging element 40 is electrically connected with the connector 30 to receive the power supply from the computer and transfer the power to charge the rechargeable battery 11 of the mouse 10.

The charging is achieved wirelessly or conductively. In a preferred embodiment of the present invention, the charging element 40 is using wireless charging which transfers energy to the rechargeable battery 11 of the mouse 10 via electromagnetic field. It is called inductive charging. The charging element 40 comprises a converting circuit 41 electrically connected with the connector 30 of the mouse pad to convert the current received from the computer to an alternating current. The charging element 40 also comprises a first induction coil 42 electrically connected with the converting circuit 41 and embedded beneath the working surface 20 of the mouse pad. The first induction coil 42 generates an alternative electromagnetic field with the alternating current pass through.

The mouse 10 also comprises a second induction coil 12 electrically connected with the rechargeable battery 11 thereof. The second induction coil 12 is embedded on the bottom of the mouse 10. When the mouse 10 is placed over the first conduction coil, the first induction coil 42 induces voltage in the second induction coil 12 which then charges the rechargeable battery 11. In this manner, the energy provided by the computer is transferred to the rechargeable battery 11 as charging.

In the preferred embodiment, the second conduction coil has an area cooperating to the bottom of the mouse 10. The first conduction coil has the same area of larger area as the second conduction coil. In the preferred embodiment the mouse pad has more than one first conduction coils distributed in different position of the mouse pad. When the mouse 10 is placed over any first conduction coil can realize charging. Therefore the total area of the first conduction coil is enlarged and the second conduction coil of the mouse 10 has more chance to be coupled with the first conduction coil. The position of the first conduction coils are also marked on the working surface 20 of the mouse pad for the user to identify.

When it is being used, the mouse pad is connected with the computer through USB. The computer provides energy to the charging element 40 of the mouse pad. The charging element 40 charges the rechargeable battery 11 of the mouse 10 when the mouse 10 is over the first conduction coil. When the user is not using the mouse 10, he/she can just move the mouse 10 on the mark on the working surface 20 of the mouse pad to charge the rechargeable battery 11. In this way, the rechargeable battery 11 will keep being charged to guarantee the power supply to the mouse 10.

In an alternative embodiment, the charging is achieved conductively. The charging element 40 comprises two charging electrodes 43 electrically connected with the charging circuit, and the mouse 10 comprises two battery electrodes 13 respectively which are electrically connected with the rechargeable battery 11. When the two charging electrodes 43 and the two battery electrodes 13 are coupled together, the charging is performing. Referring to FIG. 2, in a preferred embodiment, the charging element 40 comprises a charging lot 44 located on the corner of the mouse pad. The charging electrodes 43 are positioned at the charging lot 44 and are accessible by the battery electrodes 13 of the mouse 10. In order to properly connect the charging electrodes 43 and battery electrodes 13, the mouse pad also comprises a parking arrangement 50 which further comprises a first parking element 51 and a second parking element 52. The first parking element 51 is affixed on the charging lot 44, and the second parking element 52 is affixed on the mouse 10. When the first parking element 51 and the second parking element 52 are coupled together, the charging electrodes 43 and the battery electrodes 13 are properly aligned and well connected for charging. The coupling is detachable so the charging can be terminated anytime when the mouse 10 is needed to work. In a preferred embodiment, the first parking element 51 and the second parking element 52 are coupled by magnet.

In an alternative embodiment, the charging is achieved by other methods, for example, using USB connection for charging.

The mouse pad further comprises an indicator 60 for indicating the performance of the mouse pad. In a preferred embodiment, the indicator indicates by light. Referring to FIG. 1, the indicator has two LED 61 and 62 integrated on the two opposite edges of the mouse pad. One LED 61 is red and the other LED 62 is green. When the charging element 40 of the mouse pad is charging the rechargeable battery 11 of the mouse 10, the green LED is light 62. When the charging element 40 stops charging, but the charging element 40 and the rechargeable battery 11 are still connected or interacting, the red LED 61 is light. This provides the use a direction idea of what is happening about the charging.

In an alternative embodiment, the indicator indicates by sound. Referring to FIG. 2, the indicator comprises a speaker 70 which is located at the corner of the mouse pad. The speaker plays different sound signals representing different status of the charging performance. For example, when the charging is completed, the speak play beeps continuously.

In another embodiment, the mouse pad comprises a subwoofer and/or speakers 70. When the mouse pad is connected with the computer, the speakers 70 are electrically connected with the computer though the USB connection. Therefore the computer can play sound using these speakers 70.

In another embodiment, the mouse pad comprises a flash memory 80 embedded inside the mouse pad. When the mouse pad is connected with the computer, the flash memory 80 is electrically connected with the computer. The user can read and write the flash memory 80 as a data storage. The user can store his personal information in the flash memory 80 of the mouse pad, so when the mouse pad is connected with any computer, the personal information will be available. It is useful for many situations such as play game. The user can store his/her preferred configuration and personal information. When he/she connected the mouse pad with any computer, the information and configuration will be installed to particular game. So the user can play the game with his preferred setting. In addition, the mouse pad comprises a joystick for games which is communicatively connected with the computer wirelessly.

Alternatively, the mouse pad comprises an embedded hard drive 81 as a storage. The mouse pad also comprises USB port 82 as extension port which is able to be connected with other equipments using USB connection to communicatively connect with the computer, for example, a flash drive, or a printer, etc.

As the mouse pad comprises a suited mouse 10, the mouse pad and mouse 10 are designed in pair to have an integral effect. For example, the mouse pad is

In summary, the power mouse pad of the present invention provides large convenience for charging cordless mouse 10. It also provides a lot of functions and capabilities to expend the connection of the computers.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A power mouse pad for a computer, comprising:
a rechargeable mouse adapted for wirelessly connecting to the computer;
a mouse pad having a working surface facilitating said rechargeable mouse to work thereon;
a charging element comprising a first charging means provided at said mouse pad and a second charging means provided at said rechargeable mouse to electrically charge said rechargeable mouse when said first charging means connects with said second charging means; and
a connector provided at said mouse pad for electrically and communicatively connecting with the computer to draw electrical power from the computer in order to charge said rechargeable mouse.

2. The power mouse pad, as recited in claim 1, wherein said first and second charging means are first and second induction coils provided at said mouse pad and said rechargeable mouse in order to charge said rechargeable mouse when said first and second induction coils are wirelessly inducted.

3. The power mouse pad, as recited in claim 2, wherein said first induction coil is embedded underneath said working surface of said mouse pad in such a manner that when said rechargeable mouse is placed on top of said working surface of said mouse to align said second induction coil with said first induction coil, said rechargeable mouse is charged.

4. The power mouse pad, as recited in claim 3, wherein a mark is provided on said working surface of said mouse pad to indicate a position of said first conduction coil.

5. The power mouse pad, as recited in claim 1, wherein said first charging means comprises two charging electrodes provided at said mouse pad and said second charging means comprises two battery electrodes provided at said rechargeable mouse such that when said battery electrodes are electrically coupled with said charging electrodes, said rechargeable mouse is charged.

6. The power mouse pad, as recited in claim 5, wherein said charging element further comprises a charging lot located on a corner of said mouse pad, wherein said charging electrodes are provided at said charging lot such that when said recharging mouse is parked at said charging lot, said battery electrodes are electrically coupled with said charging electrodes to charge said rechargeable mouse.

7. The power mouse pad, as recited in claim 6, further comprising a parking arrangement for ensuring said rechargeable mouse being charged at said charging lot, wherein said parking arrangement comprises a first parking element provided at said charging lot and a second parking element provided at said rechargeable mouse, wherein said rechargeable mouse is guided to park at said charging lot via said first and second parking elements to ensure said battery electrodes being electrically coupled with said charging electrodes.

8. The power mouse pad, as recited in claim 7, wherein said first and second parking elements are magnetic elements and are coupled by magnetic force.

9. The power mouse pad, as recited in claim 1, wherein said charging element further comprises a converting circuit electrically connected with said connector of said mouse pad for convert current from the computer to charge said rechargeable mouse through said first and second charging means.

10. The power mouse pad, as recited in claim 4, wherein said charging element further comprises a converting circuit electrically connected with said connector of said mouse pad for convert current from the computer to charge said rechargeable mouse through said first and second charging means.

11. The power mouse pad, as recited in claim 8, wherein said charging element further comprises a converting circuit electrically connected with said connector of said mouse pad for convert current from the computer to charge said rechargeable mouse through said first and second charging means.

12. The power mouse pad, as recited in claim 1, further comprising an indicator for indicating a charging status of said rechargeable mouse, wherein said indicator comprise two LEDs provided at an edge of said mouse pad for generating light effect to indicate said charging status of said rechargeable mouse.

13. The power mouse pad, as recited in claim 10, further comprising an indicator for indicating a charging status of said rechargeable mouse, wherein said indicator comprise two LEDs provided at an edge of said mouse pad for generating light effect to indicate said charging status of said rechargeable mouse.

14. The power mouse pad, as recited in claim 11, further comprising an indicator for indicating a charging status of said rechargeable mouse, wherein said indicator comprise two LEDs provided at an edge of said mouse pad for generating light effect to indicate said charging status of said rechargeable mouse.

15. The power mouse pad, as recited in claim 1, further comprising a speaker provided at said mouse pad for generating sound from the computer when said connector is connected to said computer.

16. The power mouse pad, as recited in claim 13, further comprising a speaker provided at said mouse pad for generating sound from the computer when said connector is connected to said computer.

17. The power mouse pad, as recited in claim 14, further comprising a speaker provided at said mouse pad for generating sound from the computer when said connector is connected to said computer.

18. The power mouse pad, as recited in claim 1, further comprising a data storage embedded inside said mouse pad as an external storage for the computer when said connector is connected to said computer, and an extension port for externally connecting external device to the computer.

19. The power mouse pad, as recited in claim 16, further comprising a data storage embedded inside said mouse pad as an external storage for the computer when said connector is connected to said computer, and an extension port for externally connecting external device to the computer.

20. The power mouse pad, as recited in claim 17, further comprising a data storage embedded inside said mouse pad as an external storage for the computer when said connector is connected to said computer, and an extension port for externally connecting external device to the computer.
